(19) United States
(12) Patent Application Publication
(10) Pub. No.: US 2020/0079996 A1
(43) Pub. Date: Mar. 12, 2020

(54) METHOD FOR PREPARING A NANOSIZED LIGHT EMITTING SEMICONDUCTOR MATERIAL

(71) Applicant: MERCK PATENT GMBH, DARMSTADT (DE)

(72) Inventors: Nathan GRUMBACH, Efrat (IL); Inbal DAVIDI, Modiin (IL); Shany NEYSHTADT, Jerusalem (IL)

(73) Assignee: MERCK PATENT GMBH, DARMSTADT (DE)

(21) Appl. No.: 16/469,029

(22) PCT Filed: Dec. 11, 2017
(86) PCT No.: PCT/EP2017/082124

§ 371 Date: Jun. 12, 2019

(30) Foreign Application Priority Data
Dec. 15, 2016 (EP) 16204440.8

(51) Int. Cl. C09K 11/88; C09K 11/08

(52) U.S. Cl. CPC C09K 11/883; B82Y 20/00; C09K 11/0883

(57) ABSTRACT

The present invention relates to a method for preparing a nanosized light emitting semiconductor material, a nanosized light emitting semiconductor material, an optical medium comprising a nanosized light emitting semiconductor material, and an optical device comprising an optical medium.

### FIELD OF THE INVENTION

The present invention relates to a method for preparing a nanosized light emitting semiconductor material, a nanosized light emitting semiconductor material, an optical medium comprising a nanosized light emitting semiconductor material, and an optical device comprising an optical medium.

### BACKGROUND ART

A method for preparing a nanosized light emitting semiconductor material, a nanosized light emitting semiconductor material, are known in the prior art.

For example, as described in US 2015/0083969 A1, WO 2016/146719 A1, U.S. Pat. No. 8,679,543 B2, Mickael D. Tessier et al, Chem. Mater. 2015, 27, pp 4893-4898, and Mushonga et al., Materials Letters Volume 95, 15 Mar. 2013, Pages 37-39.

### PATENT LITERATURE

1. US 2015/0083969 A1
2. WO 2016/146719 A1
3. U.S. Pat. No. 8,679,543 B2

### Non Patent Literature

4. Mickael D. Tessier et al, Chem. Mater. 2015, 27, pp 4893-4898
5. Mushonga et al., Materials Letters Volume 95, 15 Mar. 2013, Pages 37-39

### SUMMARY OF THE INVENTION

However, the inventors newly have found that there is still one or more of considerable problems for which improvement is desired, as listed below.
1. A novel method for preparing a nanosized light luminescent material comprising a core/shell structure with improved Quantum Yield, is desired.
2. A novel method for preparing a nanosized light luminescent material comprising a core/shell structure, which can more precisely control shell growth of the nanosized light luminescent material, is required.
3. A novel method for preparing a nanosized light luminescent material comprising a core/shell structure, which can reduce or prevent unnecessity further core growth in shell layer making process, is desired.
4. A novel light luminescent particle comprising at least one nanosized fluorescent material with better Quantum Yield, still needs improvement.

The inventors aimed to solve one or more of the above mentioned problems 1 to 4.

Surprisingly, the inventors have found that a novel method for preparing a nanosized light emitting semiconductor material comprising a core/shell structure solves one or more of the problems 1 to 4. Preferably said method of the present invention solves all the problems 1 to 4 at the same time. Wherein the method comprises following steps (a), (b) and (c) in this sequence,

(a) synthesis of a core in a solution,

(b) adding at least one additive selected from the group consisting of metal halides represented by following chemical formula (I) and aminophosphine represented by following chemical formula (II),

M¹X¹n (I)

wherein M¹ is Zn or Cd, X¹ is a halogen selected from the group consisting of Cl, Br and I, n is 2.

(R¹R²N)₃P (II)

wherein R¹ and R² are at each occurrence, independently or dependently, a hydrogen atom or an alkyl or alkene chain having 1 to 25 carbon atoms.

(c) coating the core with said solution obtained in step (b).

In another aspect, the present invention relates to a nanosized light emitting material having a core/shell structure obtainable from said method.

In another aspect, the present invention further relates to composition comprising the nanosized light emitting material.

In another aspect, the present invention also relates to an optical medium comprising the nanosized light emitting material.

In another aspect, the present invention relates to a nanosized light emitting material having a core/shell structure obtainable from said method above.

### DETAILED DESCRIPTION OF THE INVENTION

Method

According to the present invention, said a method for preparing a nanosized light emitting semiconductor materialnanosized light emitting semiconductor material comprising a core/shell structure solves one or more of the problems 1 to 4. Preferably said method of the present invention solves all the problems 1 to 4 at the same time.

Wherein the method comprises following steps (a), (b) and (c) in this sequence.

(a) synthesis of a core in a solution,

(b) adding at least one additive selected from the group consisting of metal halides represented by following chemical formula (I) and aminophosphine represented by following chemical formula (II),

M¹X¹n (I)

wherein M¹ is Zn or Cd, X¹ is a halogen selected from the group consisting of Cl, Br and I, n is 2.

(R¹R²N)₃P (II)

wherein R¹ and R² are at each occurrence, independently or dependently, a hydrogen atom or an alkyl or alkene chain having 1 to 25 carbon atoms.

(c) coating the core with at least one shell layer using said solution obtained in step (b).

In some embodiments of the present invention, said core is a semiconducting core.

According to the present invention, the term “nanosized” means the size in between 1 nm and 999 nm.

Thus, according to the present invention, the term “a nanosized light emitting semiconductor material” is taken to mean that the light emitting material which size of the overall diameter is in the range from 1 nm to 999 nm. And in case of the material has elongated shape, the length of the overall structures of the fluorescent material is in the range from 1 nm to 999 nm.

According to the present invention, the term “quantum sized” means the size of the semiconductor material itself without ligands or another surface modification, which can show the quantum confinement effect, like described in, for example, ISBN:978-3-662-44822-9.

According to the present invention, a type of shape of the core of the nanosized light emitting material, and shape of the nanosized light emitting material to be synthesized are not particularly limited.

For examples, spherical shaped, elongated shaped, star shaped, polyhedron shaped, pyramidal shaped, tetrapod shaped, tetrahedron shaped, platelet shaped, cone shaped, and irregular shaped nanosized light emitting materials can be synthesized.

According to the present invention, the nanosized light emitting semiconductor material comprises a core/shell structure.

According to the present invention, the term “core/shell structure” means the structure having a core part and at least one shell part covering said core.

In some embodiments of the present invention, said core/shell structure can be core/one shell layer structure, core/double shells structure or core/multishell structure.

According to the present invention, the term “multishell” stands for the stacked shell layers consisting of three or more shell layers.

Each stacked shell layers of double shells and/or multishell can be made from same or different materials.

Generally, quantum sized light emitting material can emit sharp vivid colored light due to quantum size effect.

Therefore, in some embodiments of the present invention, a nanosized light emitting semiconductor material is a quantum sized light emitting material comprising II-VI, III-V, or IV-VI semiconductors, or a combination of any of these.

In some embodiments, as a combination, ternary or quaternary materials of II, III, IV, V, VI materials of the periodic table can be used.

For example, CdSe/CdS, CdSeS/CdZnS, CdSeS/CdS/ZnS, ZnSe/CdS, CdSe/ZnS, InP/ZnS, InP/ZnSe, InP/ZnSe/ZnS, InZnP/ZnS, InZnPS/ZnS, InZnP/ZnSe/ZnS, ZnSe/CdS, ZnSe/ZnS or combination of any of these, can be used preferably.

In some embodiments of the invention, the size of the overall structures of the quantum sized material, is from 1 nm to 100 nm, more preferably, it is from 1 nm to 30 nm, even more preferably, it is from 5 nm to 15 nm.

In some embodiments of the present invention, the surface of the nanosized light emitting semiconductor material can be over coated with one or more kinds of surface ligands.

Without wishing to be bound by theory it is believed that such a surface ligands may lead to disperse the nanosized fluorescent material in a solvent more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Oleylamine, Dedecyl amine (DDA), Tetradecyl amine (TDA), Hexadecyl amine (HDA), and Octadecyl amine (ODA), Oleylamine (OLA), 1-Octadecene (ODE), thiols such as hexadecane thiol and hexane thiol; mercapto carboxylic acids such as mercapto propionic acid and mercaptoundecanoic acid; carboxylic acids such as oleic acid, stearic acid, myristic acid; acetic acid and a combination of any of these. And also. Polyethylenimine (PEI) also can be used preferably.

Examples of surface ligands have been described in, for example, the laid-open international patent application No. WO 2012/059931A.

Step (a)

According to the present invention, in some embodiments, a core comprising a chemical element in group 13 of the periodic table and a chemical element in group 15 of the periodic table can be used preferably for step (c). Therefore, in a preferred embodiment of the present invention, in step (a), a core comprising a chemical element in group 13 of the periodic table and a chemical element in group 15 of the periodic table is prepared.

More preferably, said chemical element in group 13 of the periodic table is In, and said chemical element in group 15 of the periodic table is As, P, or Sb.

In some embodiments of the present invention, the core further comprises a chemical element in group 12 of the periodic table selected from Zn or Cd.

Even more preferably, the core which is prepared in step (a), is selected from the group consisting of InAs, InP, InZnP, InPZnS, InₓGa1-x-xP, InₓGa1-xZnP, InPZnSe, InCdP, InPCdS, InPCdSe, InSb, AlAs, AlP, and AlSb.

Even more preferably, the core obtained in step (a) is InP or InZnP. Zn atom can be directly onto the surface of the core or alloyed with InP. The ratios between In:P:Zn The ratio between Zn and In is in the range between 0.05 and 5. Preferably, between 0.3 and 1.

In some embodiments of the present invention, the InP based core can be prepared by using an aminophosphine represented by following chemical formula (II) as described in the section of Additive, and an In-halide precursor represented by following chemical formula (IV).

(R¹R²N)₃P (II)

wherein R¹ and R² are at each occurrence, independently or dependently, a hydrogen atom or an alkyl or alkene chain having 1 to 25 carbon atoms.

InX²₃ (IV)

wherein X² is a halogen selected from the group consisting of Cl, Br and I.

In some embodiments of the present invention, X² is I.

In a preferred embodiment of the present invention, one or more of metal halides represented by chemical formula (I) is used in step (a) to prepare the core.

More preferably, M in the chemical formula (I) is Zn. Even more preferably, the metal halide represented by chemical formula (I), which is used in step (a), is ZnCl₂.

According to the present invention, a type of shape of the core and a type of lattice of the core are not particularly limited.

For examples, spherical shaped, elongated shaped, star shaped, polyhedron shaped, pyramidal shaped, tetrapod shaped, tetrahedron shaped, platelet shaped, cone shaped, and irregular shaped core materials, a core having Zinc Blende lattice, or a polycrystalline Zinc Blende and Wurtzite can be used.

Solvent in Step (a)

According to the present invention, as a solvent, organic solvent represented by following chemical formula (III) can be used in step (a) preferably.

ZR³R⁴R⁵ (III)

wherein the formula, R³ is a hydrogen atom or an alkyl or alkene chain having 1 to 20 carbon atoms, R⁴ is a hydrogen atom or an alkyl or alkyne chain having 1 to 20 carbon atoms, R⁵ is an alkyne chain having 2 to 20 carbon atoms, Z is N, or P.

In a preferred embodiment of the present invention, Z is N.

More preferably, R³ and R⁴ are hydrogen atoms and R⁵ is an alkyne chain having 2 to 20 carbon atoms, and Z is N.

Even more preferably, the organic solvent represented by chemical formula (III) is oleylamine.

In other words, to the surface of the core in stages (a) and (b) is attached at least one ligand that is described by the following chemical formula (III),

ZR³R⁴R⁵ (III)

wherein the formula, R³ is a hydrogen atom or an alkyl or alkene chain having 1 to 20 carbon atoms, R⁴ is a hydrogen atom or an alkyl or alkyne chain having 1 to 20 carbon atoms, R⁵ is an alkyne chain having 2 to 20 carbon atoms, Z is N, or P.

In a preferred embodiment of the present invention, Z is N.

More preferably, R³ and R⁴ are hydrogen atoms and R⁵ is an alkyne chain having 2 to 20 carbon atoms, and Z is N.

Even more preferably, the organic solvent represented by chemical formula (III) is oleylamine.

In some embodiments of the present invention, to the surface of the core is attached least one ligand that is represented by chemical formula (III), and Halide ion delivered from the In-halide precursor represented by chemical formula (IV).

Step (b)

Additive in Step (b)

According to the present invention, in step (b), as an additive, metal halides represented by following chemical formula (I) and/or an aminophosphine represented by following chemical formula (II), can be used.

M¹X¹n (I)

wherein M¹ is Zn or Cd, X¹ is a halogen selected from the group consisting of Cl, Br and I, n is 2.

(R¹R²N)₃P (II)

wherein R¹ and R² are at each occurrence, independently or dependently, a hydrogen atom or an alkyl or alkene chain having 1 to 25 carbon atoms.

In a preferred embodiment of the present invention, X¹ of the formula (I) is Cl.

In a preferred embodiment of the present invention, M¹ of the formula (I) is Zn.

More preferably, M¹ of the formula (I) is Zn and X¹ of the formula (I) is Cl.

In a preferred embodiment of the present invention, wherein R¹ of the chemical formula (II) is a hydrogen atom or an alkyl chain having 1 to 25 carbon atoms, and R² of the chemical formula (II) is an alkyl chain having 1 to 25 carbon atoms.

More preferably, R¹ of the chemical formula (II) is a hydrogen atom or an alkyl chain having 5 to 20 carbon atoms, and R² of the chemical formula (II) is an alkyl chain having 5 to 25 carbon atoms.

Even more preferably, R¹ of the chemical formula (II) is a hydrogen atom, R² of the chemical formula (II) is an alkyl chain having 10 to 25 carbon atoms.

Even more preferably, the aminophosphine is hexaethylphosphorous triamide (R1=R2=CH₂CH₃) or tris [(Z)-octadec-9-enyl]amino]phosphine (R¹═H and R²═C₁₈H₃₆).

In a preferred embodiment of the present invention, said solution in step (b) comprises said metal halide represented by chemical formula (I) and said aminophosphines represented by chemical formula (II).

In a preferred embodiment of the present invention, the molar ratio between the added metal halides represented by chemical formula (I) such as ZnCl₂, and the In precursor in the initial solution in step (a) is 1<X<50 with being more preferably of 2.5<x<25

In a preferred embodiment of the present invention, the molar ratio between the added aminophosphine represented by chemical formula (II), and the In precursor in the initial solution in step (a) is in the range from 0.2 to 20. More preferably, it is in the range from 0.5 to 5.

In some embodiments of the present invention, preferably, the additives from formula (I) and (II) can be added into a reaction solution at room temperature.

In a preferred embodiment of the present invention, the anion and the cation precursors are added alternately during the synthesis, while the temperature of the solution in the synthesis increases.

More preferably, the anion and the cation precursors are added alternately during the synthesis, while the temperature of the solution in the synthesis increases from 180° C. and finishing at 320° C.

Cation Precursors for Step (b) and Shell Layer Coating in Step (c)

According to the present invention, as a cation precursor for step (b) and shell layer coating in step (c), one or more members of the group consisting of Zn-oleate, Zn-carboxylate, Zn-acetate, Zn-myristate, Zn-stearate, Zn-undecylenate, Zn-phosphonate, ZnCl₂, Cd-oleate, Cd-carboxylate, Cd-acetate, Cd-myristate, Cd-stearate and Cd-undecylenate, Cd-phosphonate, CdCl₂, can be used, with more preferably being of one or more members of the group consisting of Zn-oleate, Zn-carboxylate, Zn-acetate, Zn-myristate, Zn-stearate, and Zn-undecylenate.

More preferably, Zn oleate can be used as a cation precursor for shell layer coating step (c).

In some embodiment of the present invention, the metal halides represented by chemical formula (I) can be used as one of the cation precursors.

In some embodiments, the metal halides and the cation precursor can be mixed, or, the metal halide can be used as a single cation precursor instead of the cation precursor which is mentioned in the column of cation precursors for shell layer coating step, if necessary.

According to the present invention, as an anion precursor for step (b) and shell layer coating step (c), can be selected from one or more members of the group consisting of Se anion: Se, Se-trioctylphopshine, Se-tributylphosphine, Se-oleylamine complex, Selenourea, Se-octadecene complex, and Se-octadecene suspension.

By changing reaction time, total amount of precursors, the shell layer thickness can be controlled.

Step (c)

Shell coating step (c) can be performed like described in U.S. Pat. No. 8,679,543 B2 and Chem. Mater. 2015, 27, pp 4893-4898

Step (d)

In step (d), to remove unreacted core precursors and ligands from the solution, cleaning solution can be used preferably, between step (a) and step (b)

In a preferred embodiment of the present invention, by mixing the obtained solution from step (a) and a cleaning solution of the present invention, unreacted core precursors and ligands in said solution from step (a) can be removed.

Preferably, 1 equivalent of the crude solution is dispersed in 1 equivalent of toluene (by volume). Then, 8 equivalents (by volume) of ethanol is added to the solution. The resultant suspension is centrifuged for 5 min with the speed of 5000 rpm.

Cleaning Solution

In some embodiments of the present invention, the cleaning solution for step (d) comprises one solution selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; xylene and toluene.

In a preferred embodiment of the present invention, the cleaning solution is selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; xylene and toluene.

In a preferred embodiment of the present invention, to more effectively remove unreacted core precursors from the solution obtained in step (a) and remove the ligands leftovers in the solution, cleaning solution comprises one or more of alcohols is used.

More preferably, the cleaning solution contains one or more of alcohols selected from the group consisting of methanol, ethanol, propanol, butanol, and hexanol, and one more solution selected from xylene or toluene to remove unreacted core precursors from the solution obtained in step (a) and remove the ligands leftovers in the solution effectively.

More preferably, the cleaning solution contains one or more of alcohols selected from methanol, ethanol, propanol, and butanol, and toluene.

In some embodiments of the present invention, the mixing ratio of alcohols:toluene or xylene can be 1:1-20:1 in a molar ratio.

Preferably it is 5:1-10:1 to remove unreacted core precursors from the solution obtained in step (a) and to remove the ligands leftovers in the solution

More preferably, the cleaning removes the extra ligands and the unreacted precursor.

Nanosized Light Emitting Material

In another aspect, the present invention also relates to a nanosized light emitting material obtainable from said method of the present invention.

Thus, the present invention relates to a nanosized light emitting material obtainable from the method comprising following steps (a), (b) and (c) in this sequence.

(a) synthesis of semiconducting core in a solution,

(b) adding at least one additive selected from the group consisting of metal halides represented by following chemical formula (I) and aminophosphine represented by following chemical formula (II),

M¹X¹n (I)

wherein M¹ is Zn or Cd, X¹ is a halogen selected from the group consisting of Cl, Br and I, n is 2.

(R¹R²N)₃P (II)

wherein R¹ and R² are at each occurrence, independently or dependently, a hydrogen atom or an alkyl or alkene chain having 1 to 25 carbon atoms.

(c) coating the core with at least one shell layer using said solution obtained in step (b).

More details of the said method are described in the section of “Method”.

Optical Medium

In another aspect, the present invention further relates to an optical medium comprising the nanosized light emitting material.

In some embodiments of the present invention, the optical medium can be an optical sheet, for example, a color filter, color conversion film, remote phosphor tape, or another film or filter.

According to the present invention, the term “sheet” includes film and/or layer like structured mediums.

Optical Device

In another aspect, the invention further relates to an optical device comprising the optical medium.

In some embodiments of the present invention, the optical device can be a liquid crystal display device (LCD), Organic Light Emitting Diode (OLED), backlight unit for an optical display, Light Emitting Diode device (LED), Micro Electro Mechanical Systems (here in after “MEMS”), electro wetting display, or an electrophoretic display, a lighting device, and/or a solar cell.

### Effect of the Invention

The present invention provides;
1. a novel method for preparing a nanosized light luminescent material comprising a core/shell structure with improved Quantum Yield.
2. a novel method for preparing a nanosized light luminescent material comprising a core/shell structure, which can more precisely control shell growth of the nanosized light luminescent material.
3. a novel method for preparing a nanosized light luminescent material comprising a core/shell structure, which can reduce or prevent unnecessity further core growth in shell layer making process.
4. a novel light luminescent particle comprising at least one nanosized fluorescent material with better Quantum Yield.

### DEFINITION OF TERMS

The term “semiconductor” means a material which has electrical conductivity to a degree between that of a conductor (such as copper) and that of an insulator (such as glass) at room temperature.

The term “organic” means any material containing carbon atoms or any compound that containing carbon atoms ionically bound to other atoms such as carbon monoxide, carbon dioxide, carbonates, cyanides, cyanates, carbides, and thiocyanates.

The term “emission” means the emission of electromagnetic waves by electron transitions in atoms and molecules.

The working examples 1-5 below provide descriptions of the present invention, as well as an in detail description of their fabrication.

### WORKING EXAMPLES

### Comparative Example 1: Fabrication of a Nanosized Light Emitting Material

Core Synthesis

1.12 g of InI₃ and 1.5 g of ZnCl₂ are dissolved in 2.5 mL of oleylamine. At 180° C., 2.2 mL of hexaethylphosphorous triamide (hereafter “(DEA)₃P”) is added to the solution and it is kept at 160° C. for 20 minutes.

Shell Synthesis

Then, 0.55 mL of anion precursor (2M Trioctylphosphine (TOP):Se) is added in the solution slowly.

The solution is then heated by steps, followed by successive injections of cation (2.4 mL of 0.4M Zn(oleate) in Octadecene (hereafter ODE)) and anion (0.38 mL of 2M TOP:Se) shell precursors as described in table 1.

Finally, the obtained solution is cooled down to room temperature under inert conditions.

| Time | 20 min | 60 min | 120 min | 150 min | 180 min | 210 min | 240 min | 300 min |
|---|---|---|---|---|---|---|---|---|
| Temp. | 180° C. | 200° C. | 220° C. | 240° C. | 280° C. | 320° C. | 320° C. | 320° C. |
| Injection | anion | | cation | anion | cation | anion | cation | end |

At the end of the synthesis, the flask is cooled to room temperature. And a sample is taken from the flask for a measurement of relative Quantum Yield (QY) value and for a TEM image observation.

### Comparative Example 2: Fabrication of a Nanosized Light Emitting Material

Core Synthesis

1.12 g of InI₃ and 1.5 g of ZnCl₂ are dissolved in 2.5 mL of oleylamine.

At 160° C., 2.2 mL of hexaethylphosphorous triamide (hereafter “(DEA)₃P”) is added to the solution and it is kept at 160° C. for 20 minutes. Then, the obtained solution is cooled down and kept under inert conditions.

Core Cleaning

2.5 mL of the InP(Zn) cores are cleaned with a mixture of toluene and ethanol (ratio of the obtained solution:toluene:ethanol: 1:1:8).

Shell Coating

The cleaned cores are re-dissolved in 2.5 mL oleylamine, with addition of cation (2.4 mL of 0.4M Zn(oleate) in ODE) and anion (0.55 mL of 2M TOP:Se) shell precursor.

Then the solution is heated up by steps to 220° C. as described in Table 2, followed by successive injections of cation (2.4 mL of 0.4M Zn(oleate) in ODE) and anion (0.38 mL of 2M TOP:Se) shell precursor at temperatures between 220° C. and 320° C. The Table 2 describes the successive actions for shell coating.

TABLE 2

| Time | 0 min | 30 min | 60 min | 90 min | 120 min | 150 min | 180 min |
|---|---|---|---|---|---|---|---|
| Temp. | 180° C. | 200° C. | 220° C. | 240° C. | 280° C. | 320° C. | 320° C. |
| Injection | | | anion | cation | anion | cation | end |

At the end of the synthesis, the flask is cooled to room temperature. And a sample is taken from the flask for a measurement of relative Quantum Yield (QY) value and for a TEM image observation.

### Working Example 1: Fabrication of a Nanosized Light Emitting Material

Core Synthesis

1.12 g of InI₃ and 1.5 g of ZnCl₂ are dissolved in 2.5 mL of oleylamine.

At 180° C., 2.2 mL of hexaethylphosphorous triamide (hereafter “(DEA)₃P”) is added to the solution and it is kept at 160° C. for 20 minutes. Then, the obtained solution is cooled down and kept under inert conditions.

Core Cleaning

2.5 mL of the solution obtained in Step (a) are mixed with 22.5 mL of solution of toluene and ethanol (toluene:ethanol=1:8).

Shell Coating

The cleaned cores are re-dissolved in 2.5 mL of oleylamine with addition of cation (2.4 mL of 0.4M Zn(oleate) in ODE), anion (0.55 mL of 2M TOP:Se) shell precursor, and 150 mg of Zn(Cl)₂.

The solution is heated by steps as described in table 3, followed by successive injections of cation (2.4 mL of 0.4M Zn(oleate) in ODE) and anion (0.38 mL of 2M TOP:Se) shell precursor at temperatures between 220° C. and 320° C. The Table 2 describes the successive actions for shell coating.

TABLE 3

| Time | 0 min | 30 min | 60 min | 90 min | 120 min | 150 min | 180 min |
|---|---|---|---|---|---|---|---|
| Temp. | 180° C. | 200° C. | 220° C. | 240° C. | 280° C. | 320° C. | 320° C. |
| Injection | | | anion | cation | anion | cation | end |

At the end of the synthesis, the flask is cooled to room temperature. And a sample is taken from the flask for a measurement of relative Quantum Yield (QY) value and for a TEM image observation.

### Working Example 2: Fabrication of a Nanosized Light Emitting Material

The nanosized light emitting material is prepared in the same manner as described in working example 1 except for 150 mg of Zn(Cl)₂ and 0.16 mL of hexaethylphosphorous triamide (DEA)₃P are added in the initial reaction solution in step (c) at the same time instead of 150 mg of Zn(Cl)₂.

At the end of the synthesis, the flask is cooled to room temperature. And a sample is taken from the flask for a measurement of relative Quantum Yield (QY) value and for a TEM image observation.

### Working Example 3: Fabrication of a Nanosized Light Emitting Material

Core Synthesis

1.12 g of InI₃ and 1.5 g of ZnCl₂ are dissolved in 2.5 mL of oleylamine.

At 180° C., 2.2 mL of hexaethylphosphorous triamide (hereafter “(DEA)₃P”) is added to the solution and it is kept at 160° C. for 20 minutes.

Core Cleaning

2.5 mL of the solution obtained in Step (a) are mixed with 22.5 mL of solution of toluene and ethanol (toluene:ethanol=1:8).

Shell Coating

The solution obtained in step (b) is re-dissolved in 2.5 mL of oleylamine with addition of cation (2.4 mL of 0.4M Zn(oleate) in ODE), anion (0.55 mL of 2M TOP:Se) shell precursor, and 150 mg of Zn(Cl)₂ and 0.16 mL of hexaethylphosphorous triamide (DEA)₃P.

The solution is heated by steps as described in table 4, followed by successive injections of cation (2.4 mL of 0.4M Zn(oleate) in ODE) and anion (0.38 mL of 2M TOP:Se) shell precursor at temperatures between 220° C. and 320° C. The Table 2 describes the successive actions for shell coating.

TABLE 4

| Time | 0 min | 30 min | 60 min | 90 min | 120 min | 150 min | 180 min |
|---|---|---|---|---|---|---|---|
| Temp. | 180° C. | 200° C. | 220° C. | 240° C. | 280° C. | 320° C. | 320° C. |
| Injection | | cation | anion | cation | anion | cation | end |

At the end of the synthesis, the flask is cooled to room temperature. And a sample is taken from the flask for a measurement of relative Quantum Yield (QY) value and for a TEM image observation.

### Working Example 4: Measurements of Relative Quantum Yield (QY) Value of the Samples

The relative quantum yield is calculated using absorbance and emission spectrum (excited at 450 nm), obtained using Shimadzu UV-1800 and Jasco FP-8300 spectrophotometer, using the following formula, with Coumarin 153 dye in ethanol is used as a reference, with a quantum yield of 54.5%.

$$QY = {QY}_{ref} \frac{{n}^{2}}{{n}_{ref}^{2}} \times \frac{I}{A} \times \frac{{A}_{ref}}{{I}_{ref}}$$

Table 5 shows the measurement results of the samples.

TABLE 5

| Examples | Quantum Yield (QY) |
|---|---|
| Comparative example 1 | 0.24 |
| Comparative example 2 | 0.14 |
| Working example 1 | 0.34 |
| Working example 2 | 0.52 |
| Working example 3 | 0.46 |

The nanosized light emitting materials obtained in working example 1, 2, 3, show better Quantum Yield.

### Working Example 5: Fabrication of a Nanosized Light Emitting Material

Core Synthesis

InP cores (for green) formation starting from In-Myristate stock solution and Tris(trimethylsilyl)phosphine in 1-octadecene (here after ODE) in a similar method described by Peng. et. al. resulting in myristate capped InP QDs.

First, 0.002 mol of In-acetate and 0.006 mol of myristic acid are mixed with 25 ml of octadecene.

Once the temperature reached to 188° C., Tris(trimethylsilyl)phosphine—P(TMS)₃ in 1-octadecene (ODE) (hereafter PTMS solution) is injected into the flask. Then, the temperature is set to 178° C., where increasing amounts of In-myristate and PTMS solutions are injected. The exciton wavelength is about 515 nm.

Then, 1 equivalent of crude is dispersed in 2 equivalents of toluene and precipitated with 4 equivalents of acetone. The mixture is centrifuged for 5 min at 5000 rpm. The supernatant is discarded and the precipitated cores are dried. For the following experiment 0.685 ml crude are taken, resulting in 1.75E⁻⁷ mole cores.

Shell Coating

In a glove box, cores obtained from Step (a) are dissolved in 1.25 ml of dry oleylamine and transferred to a 50 ml round bottom flask loaded with 0.075 g of ZnCl₂ and mixed with 0.275 ml of (TOP):Se. Then the flask is vacuumed at room temperature and the mixture is heated under argon atmosphere to 180° C. for 30 minutes. The reaction is heated up to 200° C. for additional 30 minutes. Then, 1.2 ml of Zn(oleate) in ODE is added dropwise into the mixture and the temperature is raised to 220° C. for 30 minutes. Then 0.19 ml of (TOP):Se is injected slowly and the flask is again heated up to 240° C. for 30 minutes. 1.2 ml of Zn(oleate) in ODE is then injected and the flask is heated to 280° C. for 30 minutes. Then 0.19 ml of (TOP):Se is injected slowly and the flask is again heated up to 320° C. for 30 minutes. Finally, 1.2 ml of Zn(oleate) in ODE is injected and the flask is maintained at 320° C. for 60 minutes. Finally the reaction mixture is cooled down. Then sample is taken.

Then the relative Quantum Yield (QY) of the sample is measured in a same manner as described in working example 4.

The table 6 shows the results.

| Examples | Quantum Yield (QY) |
|---|---|
| Example 5 | 0.54 |

1. A method for preparing a nanosized light emitting semiconductor material comprising a core/shell structure, wherein the method comprises following steps (a), (b) and (c) in this sequence.
(a) synthesis of a core in a solution,
(a) adding at least one additive selected from the group consisting of metal halides represented by following chemical formula (I) and aminophosphine represented by following chemical formula (II),
M¹X¹n (I)
wherein M¹ is Zn or Cd, X¹ is a halogen selected from the group consisting of Cl, Br and I, n is 2.
(R¹R²N)₃P (II)
wherein R¹ and R² are at each occurrence, independently or dependently, a hydrogen atom or an alkyl or alkene chain having 1 to 25 carbon atoms,
(c) coating the core with at least one shell layer using said solution obtained in step (b).

2. Method for preparation of the nanosized light emitting material according to claim 1, wherein X is Cl.

3. Method for preparation of the nanosized light emitting material comprising a core/shell structure according to claim 1, wherein M is Zn.

4. Method for preparation of the nanosized light emitting material comprising a core/shell structure according to claim 1, wherein R¹ of the chemical formula (II) is a hydrogen atom or an alkyl chain having 1 to 25 carbon atoms, and R² of the chemical formula (II) is an alkyl chain having 1 to 25 carbon atoms.

5. Method for preparation of the nanosized light emitting material comprising a core/shell structure according to claim 1, where in R¹ is hydrogen atom, and R² is an alkyl chain having 1 to 25 carbon atoms.

6. Method for preparation of the nanosized light emitting material comprising a core/shell structure according to claim 1, wherein the aminophosphine is hexaethylphosphorous triamide or tris [(Z)-octadec-9-enyl]amino]phosphine.

7. Method for preparation of the nanosized light emitting material comprising a core/shell structure according to claim 1, wherein said solution in step (c) comprises said metal halide represented by chemical formula (I) and said aminophosphine represented by chemical formula (II).

8. Method for preparation of the nanosized light emitting material comprising a core/shell structure according to claim 1, wherein the core comprises InP and Zn.

9. Method for preparation of the nanosized light emitting material comprising a core/shell structure according to claim 1, wherein one or more of metal halides represented by chemical formula (I) is used in step (a) to synthesize the core.

10. Method for preparation of the nanosized light emitting material comprising a core/shell structure according to claim 1, wherein the total shell thickness of the shell layer(s) obtained in step (c) is 1.5 nm or more.

11. Method for preparation of the nanosized light emitting material comprising a core/shell structure according to claim 1, wherein the method further comprises following step (d) after step (a) and before step (c),
(d) removing unreacted core precursors and ligands.

12. Method for preparation of the nanosized light emitting material comprising a core/shell structure according to claim 1, wherein the core is cleaned by cleaning solution comprising one solution selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; xylene and toluene.

13. Method for preparation of the nanosized light emitting material comprising a core/shell structure according to claim 1, wherein the surface of the core in stages (a) and (d) is attached to at least one ligand that is described by the following chemical formula (II),
ZR³R⁴R⁵ (III)
wherein the formula, R³ is a hydrogen atom or an alkyl or alkene chain having 1 to 20 carbon atoms, R⁴ is a hydrogen atom or an alkyl or alkyne chain having 1 to 20 carbon atoms, R⁵ is an alkyl or alkyne chain having 2 to 20 carbon atoms, Z is N, or P.

14. Method for preparation of the nanosized light emitting material according to claim 13, wherein Z is N.

15. A nanosized light emitting material having a core/shell structure obtainable from method according to claim 1.

16. Composition comprising a nanosized light emitting material according to claim 15.

17. An optical medium comprising the nanosized light emitting material according to claim 16.

18. An optical device comprising the optical medium according to claim 17.
